(19) United States
(12) Patent Application Publication
(10) Pub. No.: US 2008/0179967 A1
(43) Pub. Date: Jul. 31, 2008

(54) Transfer Switch With Generator Runtime Counter

(75) Inventors: Todd Matthew Lathrop, Oakdale, PA (US); Ronald Dale Hartzel, Penn Township, PA (US); Bert Popovich, Carnegie, PA (US)

Correspondence Address: Martin J. Moran;Eaton Electrical, Inc., Technology & Quality Center, 170 Industry Drive, RIDC Park West, Pittsburgh, PA, 15275-1032, US

(73) Assignee: Eaton Corporation

(21) Appl. No.: 11/627,481

(22) Filed: Jan. 26, 2007

(51) Int. Cl. H01H 83/12; H02J 9/04

(52) U.S. Cl. 307/130; 307/64; 340/636.1

(57) ABSTRACT

An transfer switch having a transfer control provides electric power to a load. The transfer switch includes a power switching device provided with electric power from a first power source, such as a utility power source, and a second power source, such as a generator power source. The transfer control is structured to monitor the second power source, maintain a runtime count of the second power source, and provide an indication of the runtime count, either at the transfer switch or at a location remote from the transfer switch and the second power source.

### BACKGROUND OF THE INVENTION

1. Field of the Invention

This invention pertains generally to transfer switches and, more particularly, to transfer switches having an ability to monitor a generator power source. This invention also relates to methods for monitoring a generator power source.

2. Background Information

Transfer switches are employed in a wide variety of residential and commercial structures to allow an electrical load therein to be supplied with power from an alternate power source in the event of instability and/or loss of power from a main power source. A typical transfer switch installation allows an onsite backup electrical generator, serving as a generator power source, to supply electrical power in place of a utility power source on an occasion where the electrical power supplied by the utility power source has become unstable (e.g., as in the case of a brownout) or has failed, entirely.

In the interests of ensuring reliable operation, such a generator power source requires routine maintenance so that it will function properly when called upon to supply power in place of the main power source. More specifically, in the case of a generator powered, for example, by some form of internal combustion engine, there are lubricating oil, filters and other items that must be changed on a regular basis, as well as a fuel supply that must be replenished for such a generator to continue to function.

It is known to provide generator power sources with runtime counters as an aid to prompt personnel to carry out such routine maintenance. However, due to the high level of noise and vibration, exhaust fumes and typically unsightly appearance of such generator power sources, it is commonplace to locate such a generator power source remotely from a structure to which such a generator power source provides power. The simple fact that such a generator power source is located outside and away from such a structure typically results in gauges or other indicators mounted on such a generator power source being only infrequently checked for indications of either a prompt for routine maintenance or a malfunction. This results in routine maintenance being carried out on a less than desired basis.

It is also known to provide a generator power source installed at a location external to a structure to which the generator power source supplies power with an indicator device maintained within the structure to provide an indication of malfunctions or events that may adversely affect operation, such as a low fuel level or overheating. In this way, such indications are provided without personnel having to go out to the location of the generator power source. However, waiting for indications of malfunctions or such adverse events to address the operational needs of a generator power source is not the same as providing routine maintenance to ensure its proper operation. Therefore, such a remote indicator device does not properly address the need of prompting proper routine maintenance.

### SUMMARY OF THE INVENTION

These needs and others are met by embodiments of the invention providing a transfer switch having the ability to monitor the runtime operation of a generator power source and provide appropriate prompting of routine maintenance, including a runtime counter.

In accordance with one aspect of the invention, a transfer switch is for a first power source, a second power source, and a load. The transfer switch comprises a power switching device structured to select between the first power source and the second power source and to supply power to the load, and a transfer control structured to monitor the second power source, to maintain a runtime count of the second power source, and to provide an indication of the runtime count.

In accordance with another aspect of the invention, a method is for monitoring a second power source structured to provide power to a transfer switch including a power switching device, the power switching device being structured to receive power from a first power source and the second power source, the power switching device being operated by a transfer control, the second power source being located remotely from the transfer switch. The method comprises maintaining a runtime count of the second power source at the transfer switch, and providing an indication of the runtime count.

### BRIEF DESCRIPTION OF THE DRAWINGS

A full understanding of the invention can be gained from the following description of the preferred embodiments when read in conjunction with the accompanying drawings in which:

FIG. 1 is a block diagram of a transfer switch installation in accordance with embodiments of the invention; and

FIG. 2 is a flowchart of monitoring a generator power source and counting its runtime in accordance with another embodiment of the invention.

### DESCRIPTION OF THE PREFERRED EMBODIMENTS

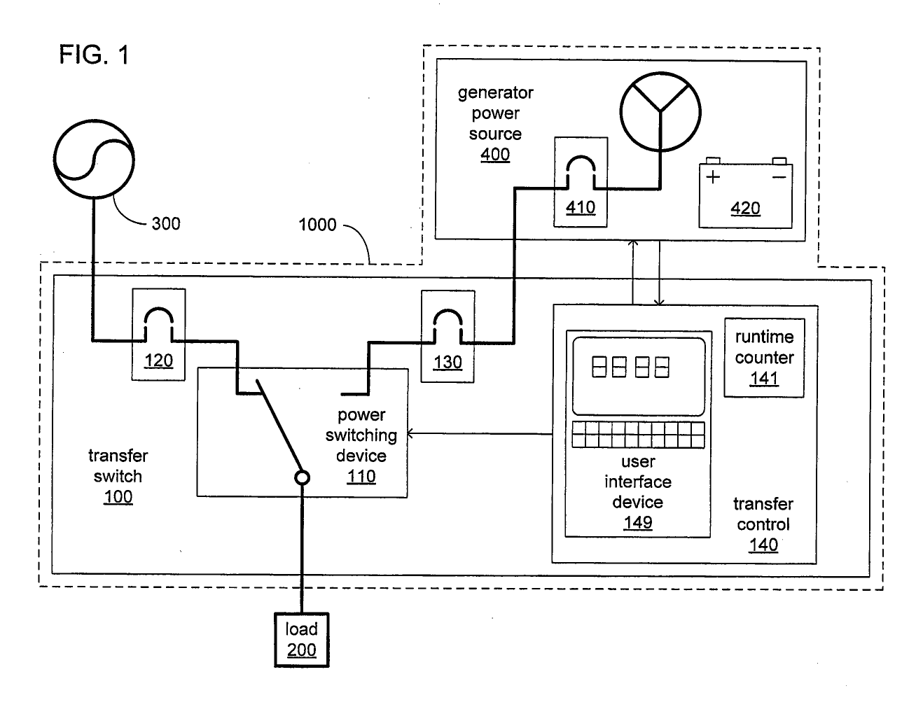

Referring to FIG. 1, a transfer switch installation 1000 to selectively provide electrical power to a load 200 from multiple alternate sources incorporates a generator power source 400 and a transfer switch 100 receiving electric power, at various times, from one or both of a utility power source 300 and the generator power source 400. The transfer switch 100 allows the source of electric power supplied to the load 200 to be switched between the utility power source 300 and the generator power source 400. The load 200 represents one or more electrical devices within, for example, a commercial or residential structure (not shown) that requires electric power, such as for example and without limitation, lighting, plug-ins, appliances, commercial machinery and climate control systems. The utility power source 300 is a source of electric power from a commercial vendor (e.g., without limitation, a connection to an electrical grid maintained by a utility power company).

The generator power source 400 is, for example, an electric generator of a type commonly found near the exterior of a commercial or residential structure to provide a backup source of electric power to that structure in the event that the electric power supplied by the utility power source 300 becomes unstable (as in the case of a brownout) or fails, entirely. The generator power source 400 may incorporate a service disconnect 410 to disconnect power during maintenance and/or in the event of an overload of current being drawn from the generator power source 400. The generator power source 400 may be any of a wide variety of electric generators based on any of a variety of technologies, including but not limited to, solar energy, wind energy, geothermal energy, or fossil fuel energy through either a fuel cell or an internal combustion engine.

The transfer switch 100 incorporates a power switching device 110, and a transfer control 140 that operates the power switching device 110. The transfer switch 100 may also incorporate one or both of service disconnects 120 and 130. Electric power from the utility power source 300 is routed via one or more conductors to the power switching device 110, and is routed through the service disconnect 120 if the service disconnect 120 is present. Electric power from the generator power source 400 is routed via one or more conductors from the generator power source 400 to the power switching device 110, and is routed through the service disconnect 130 if the service disconnect 130 is present. The power switching device 110 is caused to select either the utility power source 300 or the generator power source 400 to supply electric power that is routed via one or more conductors from the power switching device 110 to the load 200.

As those skilled in the art will readily recognize, the power switching device 110 may be any of a wide variety of devices or combinations of devices that provide the function of both making and breaking electrical connections for the routing of electric power from one of multiple electrical sources. For example, it is widely known to use one or more sets of relays and/or contactors as a power switching device.

As those skilled in the art will also readily recognize, the service disconnects 120, 130 and 410 may be any of a wide variety of devices or combinations of devices providing both protection against too great a flow of current and manual disconnection capability. A widely known and very common form of device employed as a service disconnect is a circuit breaker. Circuit breakers commonly provide a manual operating handle by which disconnection can be effected, and/or a shunt trip (e.g., a magnetic coil that when energized by an external power source causes the circuit breaker to enter an open state). Widely known and commonly used combinations of devices serving as a service disconnect are a fuse and either a latching relay or latching contactor where disconnection is caused by breaking the circuit conveying power for latching.

The power switching device 110 is normally caused by the transfer control 140 to select the utility power source 300 as the source of electric power to be supplied to the load 200, but can be caused to select the generator power source 400 when the electric power supplied by the utility power source 300 becomes unstable or fails. The transfer control 140 may be a manually operated device providing manual control over the power switching device 110, and/or the transfer control 140 may be an automated electronic device operating the power switching device 110 in response to the receipt of one or more inputs. Where the transfer control 140 is an automated electronic circuit, such inputs may include, for example and without limitation, an indication of the input voltage level supplied by one or both of the utility power source 300 and the generator power source 400 failing to meet a desired specification (e.g., failing to stay within 5% of a standard 115V level), an indication of the amount of current being drawn from either of these power sources failing to stay within a desired limit (e.g., failing to stay within the maximum current capacity of a conductor or power source), or a timer input. Regardless of whether the transfer control 140 is a manually operated device or an automated electronic device, or both, the transfer control 140 may be designed to monitor one or more forms of status.

More particularly, the transfer control 140 may monitor the voltages, current flow and/or other characteristics of the power supplied by the utility power source 300 and/or the generator power source 400. In embodiments of the transfer switch 100 in which one or both of the service disconnects 120 and 130 are provided, such sensors may be positioned between the power switching device 110 and one or both of the service disconnects 120 and 130. This may be done to detect a loss of power at one or both of the power inputs to the power switching device 110 as a result of one or both of the service disconnects 120 and 130 being opened, thereby disconnecting the power supplied by one or both of the utility power source 300 and the generator power source 400. Alternatively, the service disconnects 120, 130 and/or 410 may be structured to allow the transfer control 140 to directly monitor their status. The transfer control 140 may respond to the opening of one or more of the service disconnects 120, 130 and 410 by causing the power switching device 110 to switch between the utility power source 300 and the generator power source 400 in an effort to maintain a supply of power to the load 200.

The transfer control 140 may also be provided with the ability to turn the generator power source 400 on or off. In embodiments where the transfer control 140 is an automated electronic device, the transfer control 140 may respond to instability or complete loss of power from the utility power source 300 by signaling the generator power source 400 to turn on to provide power. The transfer control 140 may further signal the generator power source 400 to turn off when stable power is once again being supplied by the utility power source 300.

The transfer control 140 may further be provided with the ability to monitor one or more aspects of the status of the generator power source 400, such as without limitation, the amount of available fuel remaining for the generator power source 400 (e.g., without limitation, depletion of the fuel to an extent that a fuel tank is only 10% full), or the voltage level of a starting battery 420. In embodiments where the transfer control 140 is an automated electronic device, a shortage of available fuel for the generator power source 400 may cause the transfer control 140 to limit the amount of time during which the transfer control 140 signals the generator power source 400 to be turned on. A voltage level being provided by the starting battery 420 that is beneath a predetermined voltage level for a predetermined period of time (e.g., without limitation, a 12V battery providing only 10V for a period of 6 hours) may cause the transfer control 140 to limit the number of times that the generator power source 400 is signaled to be turned on, since the starting battery 420 may be close to failing.

The transfer control 140 incorporates a runtime counter 141 to count the amount of time during which the generator power source 400 is in operation (i.e., a “runtime count”). In some embodiments, the runtime counter 141 monitors the voltage of the power supplied by the generator power source 400 and counts the amount of time during which the voltage meets a predetermined threshold. Counting the runtime of the generator power source 400 in this manner has the advantage of the runtime counter having the flexibility to be able to be used with any generator supplied by any manufacturer, since whatever generator is employed as the generator power source 400 must provide power at a voltage within specifications that are appropriate for the load 200 (e.g. without limitation, 2-pole AC within 2% of 60 Hz and within 3% of 230V). In other embodiments, the runtime counter 141 monitors a status signal supplied to the transfer control 140 by the generator power source 400 that indicates when the generator power source 400 is on or off. Counting the runtime of the generator power source 400 in this manner has the advantage of likely being a more accurate indication of when the generator power source 400 is actually on, since counting the runtime by monitoring the voltage of the power received may be thwarted if a conductor conveying the power from the generator power source 400 is disconnected. In still other embodiments where the transfer control 140 sends a signal to the generator power source 400 to turn on or to turn off, the runtime counter 141 may count the passage of time between instances of sending a signal to turn on and subsequent instances of sending a signal to turn off.

A user interface device 149 providing one or more indications of status to and to receive one or more inputs from a user of the transfer switch 100 may either be incorporated into the transfer control 140 (as depicted in FIG. 1), or may be physically separate from the transfer control 140 while being either suitably electrically or wirelessly linked to the transfer control 140. Depending on the types of sensors and/or other inputs received by the transfer control 140, the user interface device 149 may provide one or more indications of voltages, current flow and/or other characteristics of power provided by one or both of the utility power source 300 and the generator power source 400. The user interface device 149 may also provide the state of the power switching device 110 (i.e., which one of the utility power source 300 and the generator power source 400 is selected by the power switching device 110), and/or of one or both of the service disconnects 120 and 130, if present. The user interface device 149 may further provide an indication of previously occurring events, such as previous changes in the selection of a power source by the power switching device 110, regardless of whether such changes were due to manual or automated operation of the power switching device 110. One or more lights, alphanumeric displays, dot-matrix displays, analog gauges, voice synthesizers, audible alarms, and/or other devices may be used to provide one or more of these indications to a user of the transfer switch 100.

The user interface device 149 also provides an indication of the runtime count maintained by the runtime counter 141. This indication may be a display of the current value of the runtime count, or an indication of when the runtime count has reached a predetermined value (e.g., without limitation, 500 hours). The runtime count may be in any of a wide variety of possible units of time measure, including but limited to, seconds, minutes, hours, multiples of hours, days, or multiples of days. The user interface device 149 may provide a control for resetting the runtime count to a predetermined initial value (e.g., without limitation, resetting to 0, or resetting to a known period of time during which the generator power source 400 may have somehow been turned on without the runtime counter having counted that period of time). In embodiments where an indication that the runtime count has reached a predetermined value, the predetermined value may be settable by a user of the transfer switch 100. A user of the transfer switch 100 may set the predetermined value to provide an indication of when the generator power source 400 has been on for a chosen amount of time, thereby necessitating the performance of some form of maintenance procedure to maintain proper functionality of the generator power source 400.

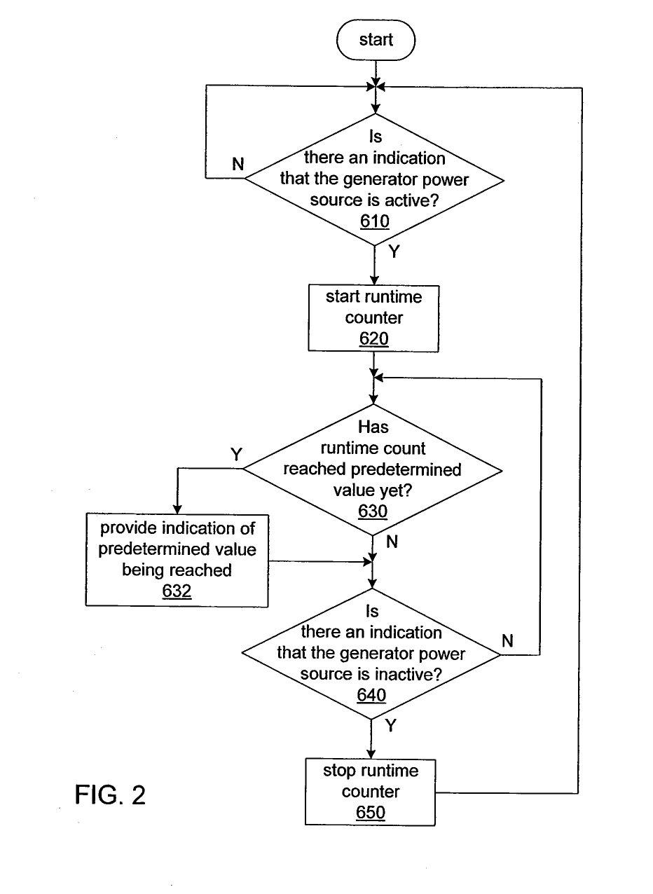

FIG. 2 shows a procedure for the monitoring of a generator power source by a transfer switch. When, at 610, there is an indication that the generator power source is active, then the runtime counter is started at 620. In some embodiments, this indication may be the provision of power from the generator power source that has a voltage or other characteristic meeting a predetermined threshold. In other embodiments, this indication be a signal (e.g., without limitation, an electrical, optical or radio frequency signal) from the generator power source indicating that the generator power source is currently on. In still other embodiments, this indication may be the transmission of a signal (e.g., without limitation, an electrical, optical or radio frequency signal) by the transfer switch to the generator power source to turn on.

If, at 630, the runtime count maintained by the runtime counter reaches a predetermined value, then an indication that the predetermined value has been reached is provided at 632. As long as there is no indication at 640 of the generator power source being inactive, whether or not the runtime count has reached the predetermined value is repeatedly checked at 630, and the runtime counter continues to run. However, if at 640, there is an indication that the generator power source is inactive, then the runtime counter is stopped at 650, and the next indication of the generator power source being active is again awaited at 610.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A transfer switch for a first power source, a second power source, and a load, said transfer switch comprising:
a power switching device structured to select between the first power source and the second power source and to supply power to the load; and
a transfer control structured to monitor the second power source, to maintain a runtime count of the second power source, and to provide an indication of the runtime count,
wherein the transfer control is structured to monitor a status signal from the second power source, and to count the runtime of the second power source by counting the time during which the status signal indicates that the second power source is operating,
wherein said second power source outputs a voltage to said power switching device, and
wherein said status signal is different than said voltage.

2. The transfer switch of claim 1, wherein the transfer control is further structured to provide a signal in response to the runtime count reaching a predetermined value.

3. The transfer switch of claim 1, wherein the power switching device comprises a contactor.

4. The transfer switch of claim 1, wherein the power switching device comprises a first service disconnect structured to receive and disconnect power from the first power source, and a second service disconnect structured to receive and disconnect power from the second power source.

5. The transfer switch of claim 1, wherein the transfer control is structured to signal the second power source to turn on and to turn off, and is further structured to count the runtime of the second power source from an instance of signaling the second power source to turn on to an instance of signaling the second power source to turn off.

6. The transfer switch of claim 1, wherein the transfer control is structured to monitor power supplied by the second power source to the power switching device, and is further structured to count the runtime of the second power source by counting the time during which the second power source supplies power having a characteristic that meets a predetermined operating parameter to the power switching device.

7. (canceled)

8. The transfer switch of claim 1, wherein the transfer control is structured to enable a user to reset the runtime count.

9. The transfer switch of claim 1, wherein the second power source includes a staffing battery having a voltage, and wherein the transfer control is structured to monitor the voltage of the staffing battery and to provide a signal when the voltage of the staffing battery falls below a predetermined value for a predetermined period of time.

10. The transfer switch of claim 1, wherein the transfer control of said transfer switch is structured to monitor a quantity of fuel available to the second power source, and is further structured to provide a signal when the quantity of fuel falls below a predetermined value.

11. A method of monitoring a second power source structured to provide power to a transfer switch including a power switching device, said second power source being further structured to output a voltage to the transfer switch, said power switching device being structured to receive power from a first power source and the second power source, said power switching device being operated by a transfer control, said second power source being located remotely from said transfer switch, said method comprising:
maintaining a runtime count of the second power source at the transfer switch;
providing an indication of the runtime count;
monitoring a status signal from the second power source, said status signal being different than said voltage; and
counting the runtime of the second power source by counting the time during which the status signal indicates that the second power source is operating.

12. The method of claim 11, said method further comprising providing a signal in response to the runtime count reaching a predetermined value.

13. The method of claim 11, said method further comprising signaling the second power source to turn on or to turn off, and counting the runtime of the second power source from an instance of signaling the second power source to turn on to an instance of signaling the second power source to turn off.

14. The method of claim 11, said method further comprising monitoring power supplied by the second power source to the power switching device, and counting the runtime of the second power source by counting the time during which the second power source supplies power having a characteristic that meets a predetermined operating parameter to the power switching device.

15. (canceled)

16. The method of claim 11, said method further comprising enabling a user to reset the runtime count.

17. The method of claim 11, said method further comprising monitoring a voltage of a starting battery of the second power source, and providing a signal when the voltage of the starting battery falls below a predetermined value for a predetermined period of time.

18. The method of claim 11, said method further comprising monitoring a quantity of fuel available to the second power source at the transfer switch, and providing a signal when the quantity falls below a predetermined value.

19. The method of claim 11, said method further comprising providing the indication of the runtime count at a location remote from the second power source and remote from the transfer switch.

20. The method of claim 11, said method further comprising providing the indication of the runtime count at the transfer switch.
